(19) United States
(12) Patent Application Publication
(10) Pub. No.: US 2021/0346730 A1
(43) Pub. Date: Nov. 11, 2021

(54) RESPIRATORY PROTECTIVE DEVICE

(71) Applicant: Metal Heart of Group of Companies Pty Ltd., Stormill (ZA)

(72) Inventors: Kenneth GRAY, Johannesburg (ZA); Gerrie Lombaard, Johannesburg (ZA)

(21) Appl. No.: 17/314,741

(22) Filed: May 7, 2021

Related U.S. Application Data
(60) Provisional application No. 63/022,228, filed on May 8, 2020.

(51) Int. Cl. A62B 18/02; A62B 7/10; A62B 23/02; A62B 18/08; A41D 13/11

(52) U.S. Cl. CPC A62B 18/02; A62B 7/10; A41D 13/1146; A62B 18/084; A62B 23/02

(57) ABSTRACT

The design is a soft flexible mask made from recyclable material that is easy to wash for re-use. It has a soft interior cavity and a hard center puck which allow for a superior seal and options for a variation of filter type and thickness. It is designed in a way that filter options and mask configuration can filter both inhalation and exhalation. It has a soft extended in-folded lip for superior seal on the face.

### RELATED APPLICATION INFORMATION

This application claims the benefit of priority to U.S. Provisional Application No. 63/022,228, filed May 8, 2020, the disclosures of each of which being incorporated herein by reference in their entirety. This application also incorporates by reference herein the disclosures of U.S. Design Pat. Application Nos. 29/735,684 and 29/736,397 in their entirety.

### FIELD OF THE INVENTION

The disclosed subject matter relates to a system for respiratory protection. Particularly, the present disclosed subject matter is directed toward a re-usable and washable respiratory protective device with a soft mounted bump in filter.

### BACKGROUND

A variety of masks are known for providing filtering and respiratory protection. However, known products suffer from a variety of shortcomings, including: Externally-attached filters risk blow off during sneeze and cough scenarios; restrictive range of filter thickness; overly rigid; imprecise fit to various facial structures; difficulty integrating with other personal protective equipment (“PPE”) devices; contribute to large amounts of contaminated waste; comprise numerous components making recycling high risk and expensive; wasted space from large size that results in greater recycled CO2 in the system; depreciated visibility of the user due to mask configuration and attachments; limitations on using different filters and number of filters based on activity of user; and/or difficulty in decontaminating the mask.

There thus remains a need for an efficient and effective protective respiratory device that addresses and overcomes one or more of the shortcomings of conventional masks.

### DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 and FIG. 3 each illustrates schematic representations of an exterior view of an exemplary respiratory protective device, in accordance with the disclosed subject matter.

FIG. 2 illustrates an exemplary side view of the respiratory protective device shown in FIG. 1.

FIG. 4 is a schematic representations of an exterior view of another exemplary respiratory protective device including a dual filter configuration, in accordance with the disclosed subject matter.

FIG. 5 is an interior view of an exemplary the respiratory protective device.

FIG. 6 is a schematic view of section A-A of the respiratory protective device shown in FIG. 2.

FIG. 7 is a perspective view of the user-facing side of the respiratory protective device shown in FIG. 4.

FIG. 8 is a perspective view of the user-facing side of an exemplary respiratory protective device.

FIG. 9A-B and FIG. 9F are perspective views of a respiratory protective device similarly constructed to the one shown in FIG. 4.

FIG. 9C-D and FIG. 9E are perspective views of the respiratory protective device similarly constructed to the one shown in FIG. 1.

FIG. 10 is a schematic view of an exemplary strap to attach the respiratory protective device disclosed herein to a user's head.

FIG. 11 is a prospective view of center puck of the respiratory protective device disclosed herein.

FIG. 12 is a perspective view of the buckle of the respiratory protective device disclosed herein.

FIG. 13 is a photograph of an exemplary respiratory protective device comprising filters, buckles, and strap as disclosed herein.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

Reference will now be made in detail to exemplary embodiments of the disclosed subject matter, an example of which is illustrated in the accompanying drawings. The method and corresponding steps of the disclosed subject matter will be described in conjunction with the detailed description of the system.

The device and systems presented herein provides a re-usable mask body 1, with improved quality of sealing between the user and the mask, the ability to simultaneously filter both inhaled and exhaled air, and results from reduced demand on raw materials for filters.

In an exemplary embodiment, a respirator mask may be provided with the flexibility allowing for improved sanitation, as the whole system can be turned inside out and washed. An interior cavity 2 may allow for increased performance both functionally for the mask during coughing and sneezing and for the user allowing for more visual range, by decreasing exterior bulk. The friction-fit polypropylene disk 4 allows for ease of use for the user and allows for a variety of filter 6 options within the cavity 2.

In accordance with an aspect of the present disclosure, the respiratory protection device includes: a single center cavity 2 allows for efficient use and improved seal by less possibility of dislodgment. Use of a single center cavity 2 may result in easier manufacturing for efficiency and sterilization.

The low volume mask disclosed herein may reduce the recycled CO₂ within the breathing space it circumscribes and thereby ensure maximum effectiveness of the filter media 6. In one embodiment, the mask body 1 comprises a relatively stiff center cavity 2 adjacent a relatively elastic cavity 1E which in combination may allow for a range of filter thicknesses and filtration types. Accordingly, the product is soft and seals better on various facial structures. In another embodiment, the mask body 1 comprises a more resilient cavity 2 circumscribed by an elastic region 2A and a channel section 1G into which a filter 6 may be frictionally held against the cavity 2 walls facing the exterior of the mask body 1. An exemplary friction fit may be encouraged by a friction section 1E or 1E′, which is the same as a friction section 1E with the addition of ridges or other extensions to further hold a puck 4 in place within the channel 1G.

The internal clip/puck 4 may promote greater visual range for the user and more space for integration with other PPE (personal protective equipment) devices. The re-usable mask allows for less contaminated waste. In an embodiment, the entirety of the device may be made out of recyclable materials, such as, for example, a thermoplastic elastomer. In another embodiment, the entirety of the device and one or more of its attachable components, including clip/puck 4, strap 5, filter 6 and buckle 3A, may be made out of the same or similar recyclable materials.

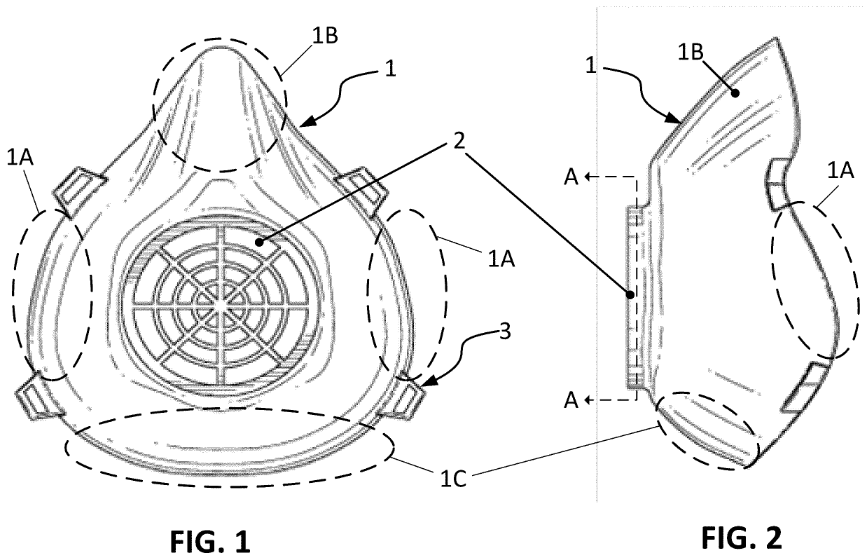

In accordance with another aspect of the disclosure, twin (FIG. 4) and single (FIG. 1) filter variances may be utilized depending on individual body requirements and/or activity level. The mask may be manufactured in different sizes to suit different facial feature, including sizing for children.

The respiratory protective devices disclosed herein presents numerous advantages over conventional masks, including providing a thermoplastic elastomer (TPE) which is a light, flexible, renewable and re-usable compound and is able to be re-sanitized for each use. Also, the in-folded lip edge 1F significantly improves the seal compared to previous masks, it is based on an anesthetic mask, and may be converted for further uses. The singular clip-in puck 4 allows for 2-way breathing filtration and reduces demand on filter material 6.

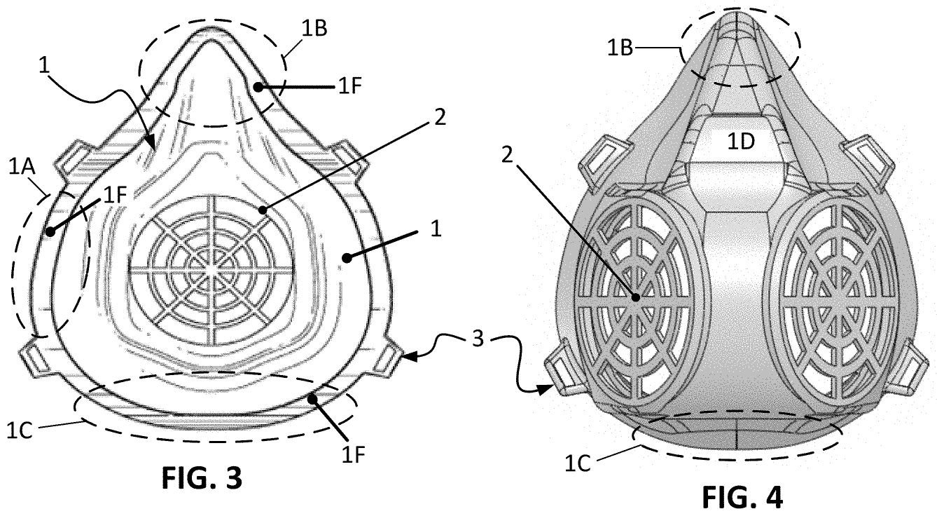

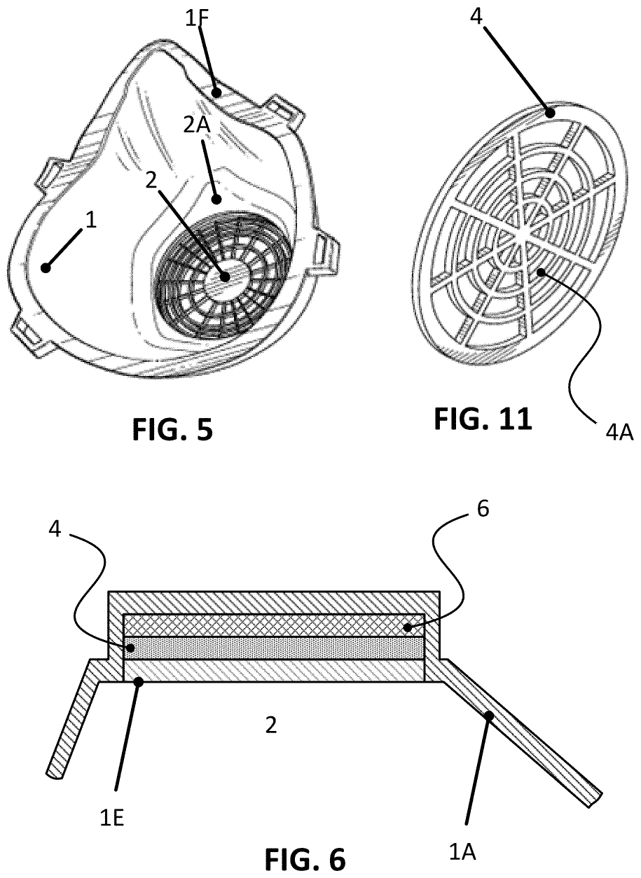

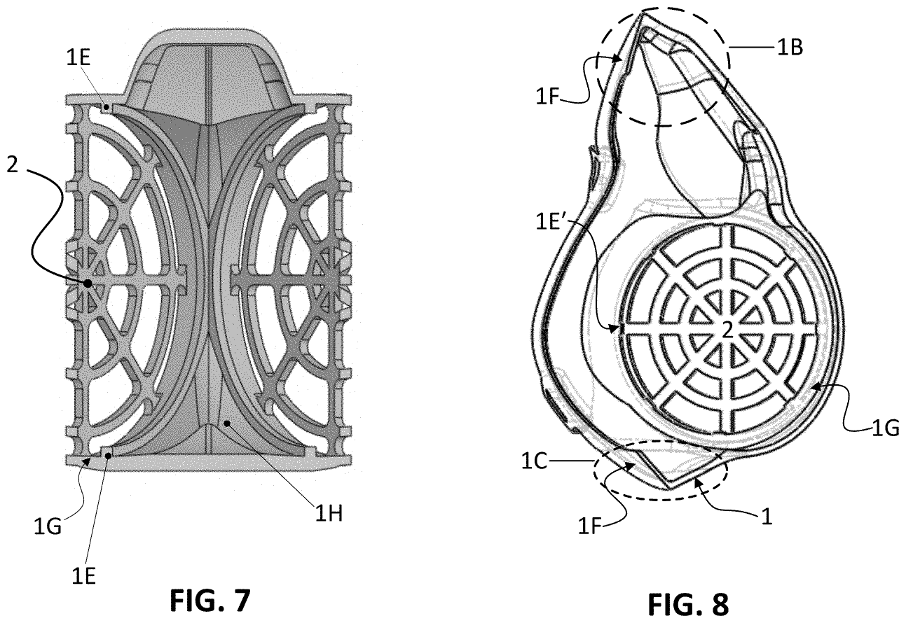

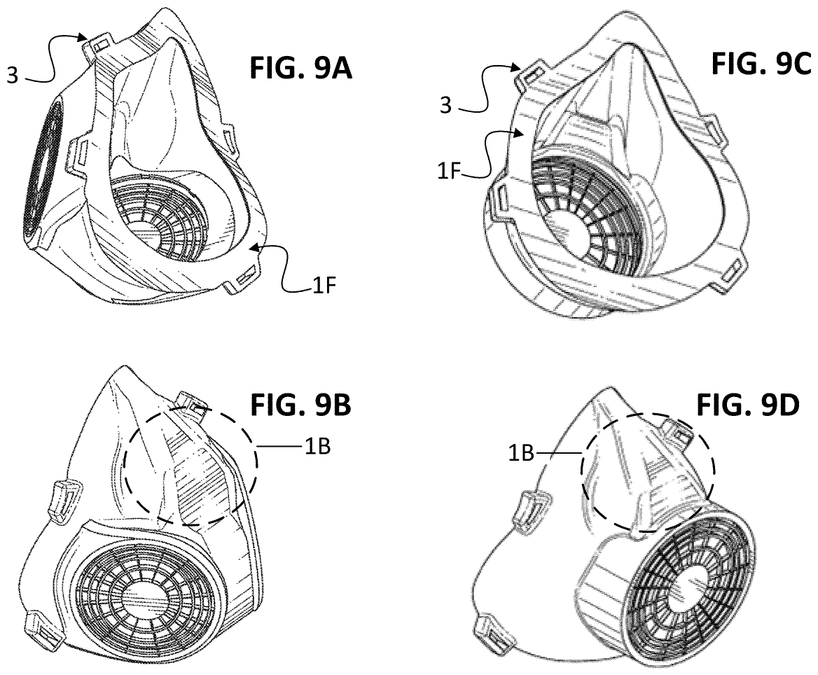

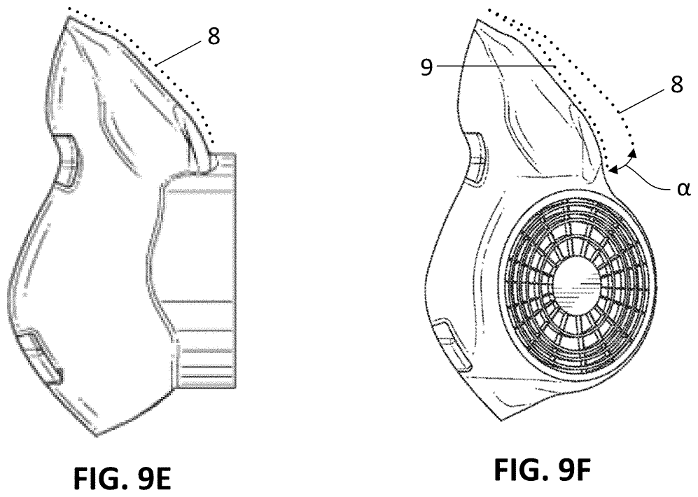

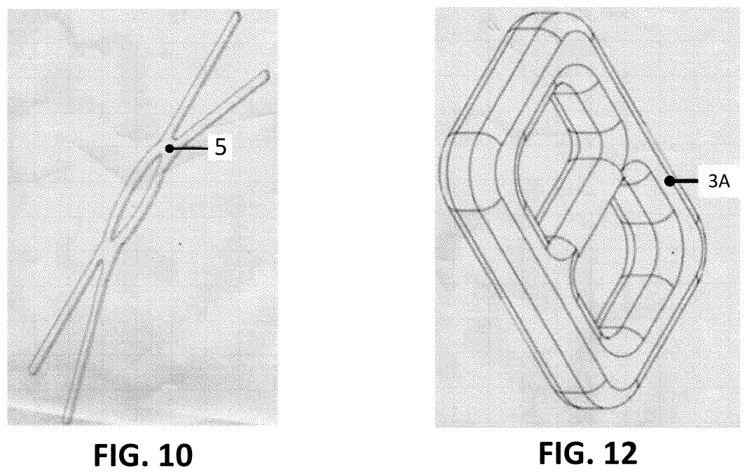

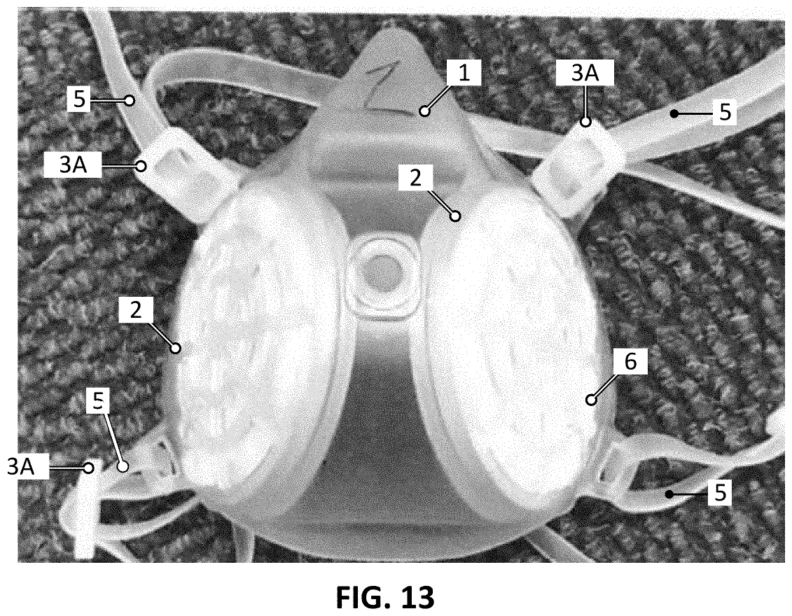

In contrast to cone-shaped masks and mask with external filters that protrude further into the eye line of the wearer, masks of the disclosed design offer a relatively narrow nasal bridge 1B having one or more quasi-universal contours 8 and/or 9 designed to reduce obstruction of line-of-sight of the wearer. For example, the nasal bridge 1B may be designed to rest on the portions of the nose of the wearer sufficiently below the eye line to allow for use of other eye-accessories (e.g., glasses, goggles). The design of the disclosed masks are able to reduce the advance of the nasal bridge 1B further up the face of the user and maintain a narrower contour 8/9 through use of sealing flap 5 in and around the nasal bridge area 1B (see, for example, FIGS. 3, 5, and 8). By virtue of the novel design of the disclosed masks, a nasal bridge contour 8 used in a mask with one cavity may deviate from the nasal bridge contour 9 used in a mask with two cavities by a marginal angle a (which is between 0 and 60 degrees). Thus, the mask design provides for multivarious cavities for any particular need/use without affecting the quasi-universal nasal bridge feature. In other words, the disclosed mask can be made for specific utilities without compromising the comfort to the user in an area where discomfort is often-times noted, i.e., the nose bridge area.

Additionally, conventional/material masks do not seal at the same level as the TPE mask body. Masks of the present disclosure include a body 1 which is durable against sweat and moisture, small amounts of facial hair, and body oils whereas other non-TPE material masks would be compromised. Another unexpected benefit of the TPE material of the present masks may be its shape-training capabilities under heated conditions. In other words, users can customize the masks to their particular faces using warm water while wearing the masks to induce the TPE material to further conform to the user's face. Another further benefit of the TPE material is that through repeated use of the mask, the material may achieve a conforming with the user's face. An exemplary TPE mask may achieve conforming of a user's face within 3 days of consistent usage for about 9 hours per day and in 16-20° C. temperature.

Another aspect of the masks disclosed herein is the option of a replaceable filter disc 6, which may expand the usage of the mask depending on the level of filter placed in the mask e.g. (FFP3 for frontline workers and FFP1 for lower risk environments). Additionally, the mask allows operation in both marine and poor weather environments due to its waterproof nature. In combination with proper filters 6, an exemplary mask offers a filtering capability in any environment.

As shown in the accompanying figures depicting exemplary embodiments of the present disclosure, the respiratory protective device disclosed herein includes the following features: Mask Body (1); Filter Cavity (2); mask body buckle (3); Center puck/disc/clip (4); Strapping (5); Filter (6). Further illustrated are the facial contact regions 1A, chin contact regions 1C, nasal bridge 1B, channel from nose to filtering zones 1D, friction region 1E, interior flap 1F, puck groove 1G, and residual holding area 1H for collection of bodily fluids exerted during mask usage. Further illustrated is flexible cavity portion 2A and strap buckles 3A. According to this exemplary embodiment, strapping 5 may comprise one integrated strap or a plurality of separate strappings. In an exemplary embodiment, a strapping 5 constructed according to the teachings disclosed herein may be expanded to approximately 5 times their starting length with no loss in elasticity and/or deformation, having an average elongation of 529%. Thus, according to one aspect of the aforementioned exemplary embodiment, a strapping constructed of TPE and as disclosed and illustrated, can be expanded to fit a variety of users without the need for re-tying or adjusting ear loops/harnesses or nose-bridge security.

In some embodiments, the straps 5 may be threaded in a number of ways to ensure a comfortable fit for the user. The filter material 6 will be prescribed as per the application and/or environment the user is in. For example, by placing filter material 6 within the cavity 2 of the mask body 1, the user may then hold that filter material 6 in place using an adequately sized and shaped puck 4, as may be illustrated in FIGS. 6 and 13. Thus, in an exemplary embodiment, filter cavity 2 may retain filter 6 within its channel 1G to create the desired seal. A user fit test may be completed quickly and safely due to extremely large internal seals.

Masks of the dual cavity type disclosed herein are capable of satisfying numerous testing criteria set forth in a number of international standards. For example, an exemplary dual cavity mask of the instant disclosure has been found to pass South African National Standard SANS 51827:2004 (Edition 1) and European National Standard EN1827:1999 (Edition 1), each of which being incorporated herein by reference in its entirety.

Dual cavity masks of the present disclosure were tested according to SANS50143 critical testing criteria. Exemplary dual cavity masks disclosed herein were fitted with FMP2-MHM64 N95/P2 filters were found to have only 1.5% penetration of sodium chloride and 2.5% paraffin oil (compared to the 6% maximum allowable penetration specifications) and breathing resistances of 70 Pa at inhalations of 30 L/min and 232 Pa at inhalations of 95 L/min. Exemplary dual cavity masks disclosed herein were reportedly comfortable and capable of secure fastening, promoted vision while in use, and resulted in no skin irritation.

Dual cavity masks of the present disclosure were tested according to NIOSH standard procedure TEB-APR-STP-0059 testing criteria, incorporated herein by reference in its entirety. Exemplary dual cavity masks disclosed herein were conditioned according to NIOSH criteria and fitted with model SP N95 filters. Exemplary dual cavity masks as conditioned and fitted were tested using TSI 8130A Automated Filter Tester according to procedures MS-6.3 Rev. 1.2 Loading Tests for Evaluation of Filter Efficiency of Respirators, incorporated herein by reference in its entirety. The exemplary dual cavity masks were subject to flows of 85 L/min 4 L/min pf sodium chloride aerosol particles at a concentration of 19.0 mg/m³±5.4 mg/m³ generated by a TSI Aerosol Generator Model 8118A and neutralized to their Boltzmann equilibrium state, having a count mean diameter of 75 nm±20 nm with a geometric standard deviation not exceeding 1.86. Exemplary dual cavity masks were found to have minimum filtration of the aforementioned aerosol at the aforementioned flow rates of between 95.3% and 97.4% and breathing resistances of between 200 Pa and 250 Pa.

As previously described, exemplary masks disclosed herein have a seal IF which may be designed in such a way as to maximize respiratory protection on both inhalation and exhalation. In combination with a TPE material, the seal 1F offers various benefits to users in promoting sealing in the facial contact regions 1A, nasal bridge areas 1B, and the chin and neck contact regions 1C. Furthermore, filters 6 with water-resistant coatings may be used with mask bodies 1 comprised of TPE, which may increase efficiency in wet weather conditions.

In another exemplary embodiment, a stiff polypropylene disc 4 may press an oversized filter 6 into the cavity 2. The cavity 2 in combination with the elastic region 2A may self-adjust to the thickness of the filter material (self-adjustment is carefully calculated in via material deformation properties). The mounting and dismounting of filter 6 from mask body 1 via cavity 2 and 2A friction fitting may allow for ease of separation of materials to make recycling easy and reduction of contaminated waste.

An exemplary mask of the types disclosed may be formed in a variety of ways, including, e.g. in an injection molder, using a tear off style manual operated cycle. The polypropylene disc 4 and buckles 3A may also be injection molded. The straps 5 may be extruded. Thus, the composition and construction of the exemplary masks permit for a rapid production of all material components and ease of recycling of all of the same. The flexibility of the exemplary mask may make it suitable for use in combination with other masks depending on needs.

Another advantage of the exemplary masks herein are derivative artistic designs could be added e.g., different colors, animal designs on the exterior to make it more welcoming for children. etc. Thus, the customization and creativity that has come to be associated with felt masks can be translated to more robust masks.

In operation, a user would choose appropriate level of filtration for environment; place the filter 6 on the inside of the mask in filter cavity 2; clip the inner seal “puck” disc 4 in place sealing the airway with the filter 6, and use the mask body in accordance with seal specifications.

As shown in FIG. 11, an exemplary puck 4 may be any size or shape that creates an interference fit with the filter cavity 2. Exemplary pucks may be sized from 60 mm in overall diameter to 110 mm in overall diameter. While an exemplary puck 4 may comprise arched slits through its surface, other designs are contemplated, such as meshes, honey-comb structures, circular cut-outs, and longitudinal and/or lateral slat designs. In some embodiments, the friction fit results from deflecting filter cavity 2 inside out via elastic region 2A. When deflected, elastic ridge regions 1E (or 1E′ as the case may be), will extend outwardly as well to allow for placement of the filter material 6 first and then receipt of puck 4 within channel 1G. In another exemplary embodiment, filter 6 and puck 4 may be combined by way of glue, welding, knitting, sewing, or other adhesive and simultaneously be placed within the filter cavity 2. Thus, in accordance with these embodiments, the filter 6 introduction to mask body 1 requires limited additional components that further reduce the potential points of leakage (e.g, gaps in screw sealing portions in prior art masks). In another exemplary embodiment, any filter material that is over-sized in the cavity 2 may still be brought into tight interference fit with the mask body 1 on the interior so as to ensure maximum filtration.

Residual build of body fluids during mask usage may be expected, and the residual body fluid region 1H may be provided for such a purpose. The use of elastic ridge regions 1E/1E′ may be utilized as a protective barrier between filter 6 and the collected fluids. In an exemplary embodiment, an elastic ridge region 1E′ may extend partially away from cavity 2 towards the user to create a canopy-like structure over the fluid collection region 1H. Alternatively, an exhalation means (not shown) may be utilized in and around the fluid collection region 1H to allow for emptying the fluids collected during use.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

The invention claimed is:

1. A respiratory protective device, comprising:
a flexible mask body comprised of a thermoplastic elastomer, wherein the flexible mask body has a nasal bridge extending outwardly from the mask and a sealing lip extending inwardly from a rim of the mask;
a cavity integrally formed in the flexible mask body and located proximal to the nasal bridge, wherein the cavity possesses a lesser degree of flexibility as compared to the mask body;
a flexible region in the mask body circumscribing the cavity, the flexible region configured to frictionally hold therein a filter and a plastic puck, wherein the puck is disposed in substantial contact with the filter when residing within the cavity.

2. The respiratory protective device of claim 1, wherein the puck is frictionally located within the cavity.

3. The respiratory protective device of claim 1, further comprising at least two cavities each of which being located proximal to the nasal bridge.

4. The respiratory protective device of claim 2, further comprising a filter disposed within the cavity and in substantial contact with the puck.

5. The respiratory protective device of claim 4, wherein the puck and the filter are interconnected.

6. The respiratory protective device of claim 2, further comprising a filter disposed within the cavity and in substantial contact with the puck.

7. The respiratory protective device of claim 1, wherein the sealing lip extends about the nasal bridge.

8. The respiratory protective device of claim 1, wherein the sealing lip is substantially orthogonal from the axis of the cavity.

9. The respiratory protective device of claim 1, wherein the mask body further comprises buckling means for a strap formed integrally with the mask body.

10. The respiratory protective device of claim 1, wherein the puck comprises a plurality of openings for passage of air through the filter and the mask body.

11. The respiratory protective device of claim 1, wherein the elastic region comprises at least one ridge and at least one channel configured to frictionally retain the puck.

12. The respiratory protective device of claim 11, wherein the elastic region comprises at least one ridge and at least one channel configured to frictionally retain the puck and the filter.

13. The respiratory protective device of claim 1, wherein the mask body in combination with the puck and the filter satisfy SANS 51827:2004 standards.

14. A method of loading a respiratory protective device, comprising the steps of:
flexing a mask body to allow for access to a flexible cavity integrally formed therewith;
expanding one of a ridge or a channel in the flexible cavity;
placing a filter into the flexible cavity;
placing a puck into the channel of the flexible cavity;
releasing the mask body so that the ridge holds the puck to the filter in the cavity.

15. The method of claim 14, wherein the step of flexing the mask body includes flexing the mask body so that it is at least partially inside out.

16. The method of claim 14, further comprising the step of flexing a second cavity integrally formed in the mask body.

17. The method of claim 16, further comprising the step of placing a filter into the second cavity and then placing a puck into a channel of the second cavity.

18. The method of claim 17, wherein the step of releasing the mask body takes place after the step of placing the filter into the second cavity.

19. A recyclable respiratory protective system, comprising:
a fully recyclable mask body;
a fully recyclable puck for frictionally-fitting within a cavity in the mask body; and
a fully recyclable strap for harnessing to the mask body.

20. The recyclable respiratory protective system of claim 19, wherein each of the mask body, the puck, and the strap are made from a thermoplastic elastomer.
